(19) United States
(12) Patent Application Publication
(10) Pub. No.: US 2010/0182883 A1
(43) Pub. Date: Jul. 22, 2010

(54) RECORDING APPARATUS AND RECORDING LASER POWER SETTING METHOD

(75) Inventor: Kazutaka Imamura, Kanagawa (JP)

Correspondence Address: WOLF GREENFIELD & SACKS, P.C., 600 ATLANTIC AVENUE, BOSTON, MA, 02210-2206, US

(73) Assignee: Sony Optiarc Inc., Kanagawa (JP)

(21) Appl. No.: 12/690,524

(22) Filed: Jan. 20, 2010

(30) Foreign Application Priority Data
Jan. 22, 2009 (JP) 2009-011859

(51) Int. Cl. G11B 7/00

(52) U.S. Cl. 369/47.5; G9B/7

(57) ABSTRACT

A recording apparatus includes: an optical head section to irradiate a laser beam onto a recording medium and perform recording, reproduction, or erase of information; a laser drive section to drive the optical head section to output the laser beam; a modulation-degree measurement section to measure a modulation degree of a signal read out by the optical head section; and a control section to execute controlling the laser drive section and the optical head section to execute the recording and the erase on a test area of the recording medium while varying a laser power, calculating a power reference value based on an erase characteristic and a reproduced signal growth characteristic in accordance with the variation of the laser power, each of the characteristics being obtained by acquiring a modulation-degree measurement value of a reproduced signal, and setting a recording laser power by using the power reference value.

### BACKGROUND OF THE INVENTION

1. Field of the Invention

The present invention relates to a recording apparatus for recording media such as optical discs, and a recording laser power setting method for the recording apparatus.

2. Description of the Related Art

It is necessary to perform optimization of a recording laser power, so-called OPC (Optimum Power Control), on recordable recording media such as phase-change optical discs, and thus various techniques therefor have been proposed.

As a technique called γ method, Japanese Patent No. 3124721 and Japanese Patent No. 3801000 (hereinafter, referred to as Patent Document 2) disclose techniques for obtaining an optimum value of a laser power with respect to an optical disc with use of parameters such as a target γ value, a ρ ratio, and the like.

Particularly in Patent Document 2, a method of approximating the target γ value is disclosed.

Moreover, Japanese Patent Application Laid-open No. 2000-137918 and Japanese Patent No. 3259642 disclose methods of detecting a minimum value of an error index such as a jitter value with respect to a power change and setting the minimum value as an optimum power.

### SUMMARY OF THE INVENTION

Incidentally, the techniques of related art still leave the following problems.

In the method of detecting a minimum value of an error index such as a jitter value with respect to a power change and setting the minimum value as an optimum power, an excessive recording power may be imparted in order to detect an optimum recording laser power in some cases. Since a phase-change recording medium has a test area to be repeatedly used, when damage to the medium due to the excessive recording power is taken into consideration, it is not desirable to execute the OPC by a recording power that largely exceeds an optimum value thereof.

On the other hand, in the γ method, investigations and operations for obtaining optimum values for all recording media in relation to two parameters, i.e., the target γ value and the ρ ratio, have been extremely tough in actual mass production design.

In addition, in the OPC technique in which a modulation degree of a reproduced RF signal is used, such as the γ method as related art, there arise the following problems regarding a reproduced RF signal having a low modulation degree (lower power area), which lead to difficulty in practical operations.

1. Electric or optical noise components are added to a reproduced RF signal and thus measurement accuracy is significantly lowered.

2. A low-power recording is significantly influenced by sensitivity variation within a circumference of a recording medium, and the like.

3. In the low-power recording, a difference between a growth of the RF formed by a long mark and a growth of the RF formed by a short mark is generated, and therefore a modulation-degree curve is deformed in a complicated manner at a time of reproduction.

4. Even if only a mark having a single length is recorded, growths of the RF with respect to a recording power are different between a head portion of the formed mark and a tail end portion thereof, and thus deformation is generated in the modulation-degree curve at the time of reproduction.

In this regard, it is desirable to prevent an excessive power from being provided, prevent processing from being made based on a low modulation degree of a reproduced RF signal in a case where recording is performed by a low power, and allow OPC to be executed using a single parameter.

According to an embodiment of the present invention, there is provided a recording apparatus including: an optical head section to irradiate a laser beam onto a recording medium and perform one of recording, reproduction, and erase of information; a laser drive section to drive the optical head section so that the optical head section outputs the leaser beam; a modulation-degree measurement section to measure a modulation degree of a signal read out by the optical head section; and a control section to execute, as recording laser power setting processing by which a recording laser power output from the optical head section is set, controlling the laser drive section and the optical head section to execute the recording and the erase on a test area of the recording medium while varying a laser power, calculating a power reference value based on an erase characteristic and a reproduced signal growth characteristic in accordance with the variation of the laser power, each of the erase characteristic and the reproduced signal growth characteristic being obtained by controlling the optical head section to reproduce the test area and acquiring a modulation-degree measurement value of a reproduced signal from the modulation-degree measurement section, and setting the recording laser power by an operation using the power reference value.

Further, the recording laser power setting processing is performed with a ratio of the recording laser power to an erase laser power being kept constant.

Further, the control section controls the laser drive section and the optical head section to execute the recording laser power setting processing including, as first processing, performing recording on the test area by the laser power set to be a predetermined fixed value, as second processing, performing erase on the test area subjected to the recording in the first processing while varying the laser power in a range of the fixed value or less, as third processing, performing reproduction on the test area subjected to the erase in the second processing and calculating the erase characteristic from the modulation-degree measurement value obtained by the modulation-degree measurement section, as fourth processing, performing the recording on the test area in a completely-erased state while varying the laser power in the range of the fixed value or less, as fifth processing, performing the reproduction on the test area subjected to the recording in the fourth processing and calculating the reproduced signal growth characteristic from the modulation-degree measurement value obtained by the modulation-degree measurement section, and as sixth processing, setting a power of a matching point of the erase characteristic and the reproduced signal growth characteristic as the power reference value and setting the recording laser power by the operation using the power reference value.

Further, the control section executes the second processing multiple times.

Further, the control section controls the laser drive section and the optical head section to execute the recording laser power setting processing including, as first processing, performing recording on the test area by the laser power set to be a predetermined fixed value and forming a mark and a space on the test area, as second processing, performing the recording on the space and erase on the mark in the test area subjected to the recording in the first processing while varying the laser power in a range of the fixed value or less, as third processing, performing reproduction on the test area subjected to the second processing and calculating a combination characteristic of the erase characteristic and the reproduced signal growth characteristic from the modulation-degree measurement value obtained by the modulation-degree measurement section, and as fourth processing, setting the recording laser power by the operation using the power reference value determined from the combination characteristic.

Further, the control section controls the laser drive section and the optical head section to execute the recording laser power setting processing including, as first processing, performing recording on the test area by the laser power set to be a predetermined fixed value and forming a mark and a space on the test area, as second processing, performing erase on the test area subjected to the recording in the first processing while varying the laser power in a range of the fixed value or less, as third processing, performing the recording on the space and erase on the mark in the test area subjected to the recording in the first processing while varying the laser power in the range of the fixed value or less, as fourth processing, performing reproduction on the test area subjected to the third processing and calculating a combination characteristic of the erase characteristic and the reproduced signal growth characteristic from the modulation-degree measurement value obtained by the modulation-degree measurement section, and as fifth processing, setting the recording laser power by the operation using the power reference value determined from the combination characteristic.

According to another embodiment of the present invention, there is provided a recording laser power setting method including: performing recording and erase on a test area of a recording medium while varying a laser power output from an optical head section; reproducing the test area by the optical head section and acquiring a modulation-degree measurement value of a reproduced signal; calculating a power reference value based on an erase characteristic and a reproduced signal growth characteristic in accordance with the variation of the laser power, each of the erase characteristic and the reproduced signal growth characteristic being obtained from the modulation-degree measurement value; and setting a recording laser power by an operation using the power reference value.

In the embodiments as described above, the modulation degree of the reproduced signal (reproduced RF signal) is measured as the results of the recording and the erase performed while varying the laser power, and the power reference value is calculated using the erase characteristic and the reproduced signal growth characteristic. Then, the power corresponding to an intersection of an erase characteristic curve and a reproduced signal growth characteristic curve is set as the power reference value, for example. Alternatively, a similar power reference value can also be calculated from a combination characteristic curve obtained from the erase characteristic curve and the reproduced signal growth characteristic curve. Specifically, the power reference value is a point at which the modulation degree of a process in which the erase advances and the modulation degree of a process in which the growth advances match.

By setting the power reference value to be a point having a relatively-high modulation degree, it is possible to prevent lowering of accuracy in a low modulation area.

Moreover, an excessively-high laser power is unnecessary to be irradiated in the OPC processes.

In addition, by calculating the power reference value, it is possible to calculate an optimum recording laser power by the operation using one parameter (coefficient) and make a setting of the recording laser power.

According to the embodiments of the present invention, by using the power reference value obtained from the erase characteristic and the reproduced signal growth characteristic, it becomes possible to operate distribution of the OPC results with only a specific coefficient instead of a plurality of parameters required in the past, with the result that the number of processes can be largely reduced when a large number of recording media are investigated in actual mass production design.

Further, in the actual use, results obtained from an RF signal having a low modulation degree of unstable measurement accuracy can be prevented from being used as OPC processing, with the result that determination accuracy of the recording laser power can be improved.

Furthermore, the predetermined fixed value is set as the upper limit of the power and a power largely exceeding an optimum power is not used in the test (OPC), with the result that there is no fear that a test area of a recording medium may be damaged.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a block diagram of a disc drive apparatus according to an embodiment of the present invention;

FIG. 2 is an explanatory diagram of a recording power and an ε value of the embodiment;

FIG. 3 is a flowchart of OPC processing of a first embodiment;

FIG. 4 are explanatory diagrams showing an erase characteristic curve of the first embodiment;

FIG. 5 are explanatory diagrams showing an RF growth characteristic curve of the first embodiment;

FIG. 6 are diagrams for explaining setting of a reference point of the first embodiment and a second embodiment;

FIG. 7 is a flowchart of OPC processing of the second embodiment;

FIG. 8 are explanatory diagrams showing an erase characteristic curve of the second embodiment;

FIG. 9 are flowcharts of OPC processing of a third embodiment and a fourth embodiment;

FIG. 10 are explanatory diagrams showing recording/erase operations of the third embodiment;

FIG. 11 are explanatory diagrams showing a combination characteristic curve of the third embodiment;

FIG. 12 are explanatory diagrams showing a combination characteristic curve of the fourth embodiment;

FIG. 13 are explanatory diagrams showing test results of the embodiments; and

FIG. 14 are explanatory diagrams showing test results of the embodiments.

### DESCRIPTION OF PREFERRED EMBODIMENTS

Hereinafter, embodiments of the present invention will be described. Herein, a disc drive apparatus that performs recording and reproduction with respect to a phase-change optical disc is taken as an example of a recording apparatus of the embodiments of the present invention, and an OPC operation thereof is described. Descriptions will be made in the following order.

(1. Structure of disc drive apparatus)
(2. OPC operation as first embodiment)
(3. OPC operation as second embodiment)
(4. OPC operation as third embodiment)
(5. OPC operation as fourth embodiment)
(6. Test results of OPC operations according to embodiments)

### 1. Structure of Disc Drive Apparatus

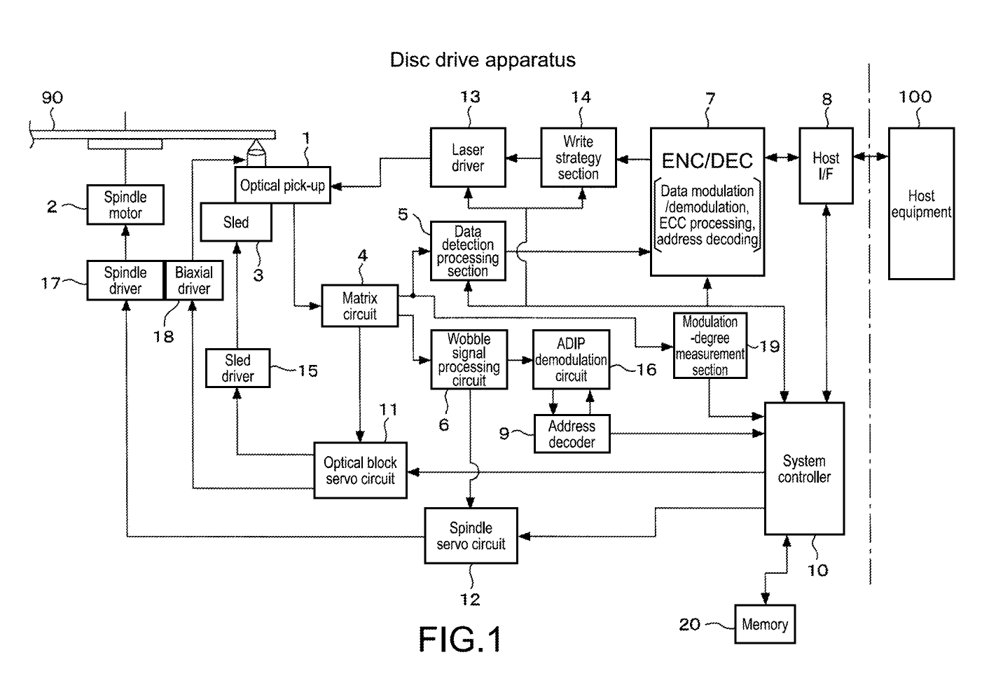

A structure of a disc drive apparatus of an embodiment will be described with reference to FIG. 1.

The disc drive apparatus of this embodiment is a recording/reproducing apparatus that performs recording and reproduction with respect to optical discs such as a Blu-ray Disc (registered trademark) and a DVD (Digital Versatile Disc), and has a feature in an OPC (Optimum Power Control) operation particularly with respect to phase-change discs (rewritable discs).

An optical disc 90 is placed on a turntable (not shown) when being mounted to the disc drive apparatus, and rotatably driven by a spindle motor 2 at a constant linear velocity (CLV) in recording/reproducing operations.

At a time of reproduction, an optical pick-up (optical head section) 1 reads out mark information recorded on tracks of the optical disc 90.

Further, at a time of recording data on the optical disc 90, the optical pick-up 1 records user data as a phase-change mark on the tracks of the optical disc 90.

It should be noted that though physical information and the like of the disc is recorded as management information specific to reproduction by embossed pits or wobbling grooves in an inner circumferential area 91 of the optical disc 90, those pieces of information are also read out by the optical pick-up 1.

Moreover, ADIP (Address in Pregroove) information embedded as wobbling of groove tracks on the optical disc 90 is also read out from the optical disc 90 by the optical pick-up 1.

Formed in the optical pick-up 1 are a laser diode to become a laser source, a photodetector for detecting reflected light, an object lens to become an output end of a laser beam, an optical system in which a laser beam is irradiated onto a recording surface of a disc through the object lens and reflected light thereof is guided to the photodetector, and the like.

In the optical pick-up 1, the object lens is held so as to be movable in a tracking direction and a focusing direction by a biaxial mechanism.

Further, the whole optical pick-up 1 is movable in a disc radius direction by a sled mechanism 3.

Furthermore, the laser diode in the optical pick-up 1 is driven to emit a laser beam by a drive signal (drive current) supplied from a laser driver 13.

Reflected light information from the optical disc 90 is detected by the photodetector, converted into an electric signal in accordance with an amount of received light, and supplied to a matrix circuit 4.

The matrix circuit 4 includes a current-voltage conversion circuit, a matrix operation/amplifier circuit, and the like so as to correspond to output currents that are output from a plurality of light-receiving devices as photodetectors, and generates necessary signals by matrix operation processing.

For example, the matrix circuit 4 generates a reproduced information signal corresponding to reproduced data (RF signal), a focusing error signal and a tracking error signal for servo control, and the like.

Moreover, the matrix circuit 4 generates a signal related to wobbling of grooves, that is, a push-pull signal as a signal for detecting wobbling.

The RF signal output from the matrix circuit 4 is supplied to a data detection processing section 5 and a modulation-degree measurement section 19, the focusing error signal and the tracking error signal are supplied to an optical block servo circuit 11, and the push-pull signal is supplied to a wobble signal processing circuit 6, respectively.

The data detection processing section 5 binarizes the RF signal.

For example, the data detection processing section 5 performs A/D conversion processing, reproduction clock generation processing by PLL, PR (Partial Response) equalization processing, Viterbi decoding (maximum likelihood decoding) and the like on the RF signal, and obtains a binary data sequence by partial response maximum likelihood decoding (PRML (Partial Response Maximum Likelihood) detection method).

Then, the data detection processing section 5 supplies the binary data sequence as the information read out from the optical disc 90 to an encoding/decoding section 7 in a subsequent stage.

The encoding/decoding section 7 demodulates reproduced data at a time of reproduction and modulates recording data at a time of recording. In other words, the encoding/decoding section 7 performs data demodulation, deinterleaving, ECC decoding, address decoding, and the like at the time of reproduction, and ECC encoding, interleaving, data modulation, and the like at the time of recording.

At the time of reproduction, the binary data sequence decoded in the data detection processing section 5 is supplied to the encoding/decoding section 7. The encoding/decoding section 7 demodulates the binary data sequence and obtains the reproduced data from the optical disc 90.

For example, the reproduced data from the optical disc 90 is obtained by performing demodulation on the data that has been subjected to run length limited encoding and recorded on the optical disc 90, performing ECC decoding as error correction, and the like.

The data decoded into the reproduced data in the encoding/decoding section 7 is transferred to a host interface 8, and then transferred to host equipment 100 in accordance with an instruction of a system controller 10. Examples of the host equipment 100 include a computer apparatus and AV (Audio-Visual) system equipment.

The ADIP information is processed at the time of performing recording/reproduction on the optical disc 90.

In other words, the push-pull signal output from the matrix circuit 4 as a signal related to wobbling of grooves is converted into digital wobble data in the wobble signal processing circuit 6. In addition, a clock synchronized with the push-pull signal is generated by PLL processing.

The wobble data is demodulated into a data stream constituting an ADIP address in an ADIP demodulation circuit 16 and the data stream is supplied to an address decoder 9.

The address decoder 9 decodes the supplied data to obtain an address value, and then supplies it to the system controller 10.

At the time of recording, recording data is transferred from the host equipment 100. The recording data is supplied to the encoding/decoding section 7 via the host interface 8.

In this case, the encoding/decoding section 7 performs error correction code addition (ECC encoding), interleaving, sub-code addition, and the like as encoding processing of the recording data. Further, the run length limited encoding is performed on the data that has been subjected to the above processing.

The recording data processed by the encoding/decoding section 7 is converted into a laser drive pulse in a write strategy section 14, the laser drive pulse having been subjected to recording compensation processing such as fine adjustment of an optimum recording power with respect to characteristics of recording layers, a shape of a laser beam spot, and a recording linear velocity and adjustment of a waveform of the laser drive pulse. The write strategy section 14 supplies the laser drive pulses to the laser driver 13.

The laser driver 13 supplies the laser drive pulse that has been subjected to the recording compensation processing to the laser diode in the optical pick-up 1 to cause the laser diode to emit a laser beam. Accordingly, marks corresponding to the recording data are formed on the optical disc 90.

It should be noted that the laser driver 13 includes a so-called APC (Auto Power Control) circuit and controls a level of a laser output to be constant regardless of a temperature or the like while monitoring a power of the laser output based on an output of a detector for monitoring the laser power, the detector being provided in the optical pick-up 1.

The laser driver 13 is supplied with a target value of the level of the laser output for recording and reproduction from the system controller 10, and controls the level of the laser output to take the target value at the time of recording and the reproduction.

An optimum laser power in the recording is set by OPC processing described later.

The optical block servo circuit 11 generates various types of servo drive signals for focusing, tracking, and sled based on the focusing error signal and the tracking error signal that are supplied from the matrix circuit 4, thus executing a servo operation.

Specifically, the optical block servo circuit 11 generates a focusing drive signal and a tracking drive signal in accordance with the focusing error signal and the tracking error signal, and drives a focusing coil and a tracking coil of the biaxial mechanism within the optical pick-up 1 by a biaxial driver 18. Accordingly, the optical pick-up 1, the matrix circuit 4, the optical block servo circuit 11, the biaxial driver 18, and the biaxial mechanism constitute a tracking servo loop and a focusing servo loop.

Further, the optical block servo circuit 11 turns off the tracking servo loop in response to a track jump instruction sent from the system controller 10 and executes a track jump operation by outputting a jump drive signal.

Moreover, the optical block servo circuit 11 generates a sled drive signal based on a sled error signal obtained as a low frequency component of the tracking error signal, access execution control from the system controller 10, and the like, to thereby drive the sled mechanism 3 by a sled driver 15. Though not shown in FIG. 1, the sled mechanism 3 has a mechanism constituted of a main shaft for holding the optical pick-up 1, a sled motor, a transmission gear, and the like. When the sled motor is driven in accordance with the sled drive signal, a required slide movement of the optical pick-up 1 is conducted.

A spindle servo circuit 12 controls the spindle motor 2 to execute the CLV rotation.

The spindle servo circuit 12 obtains the clock generated by the PLL processing for the wobble signal, as current rotational speed information of the spindle motor 2, and compares it with predetermined CLV reference speed information to thus generate a spindle error signal.

Alternatively, since the reproduced clock generated by the PLL processing performed in the data detection processing section 5 serves as current rotational speed information of the spindle motor 2 at the time of data reproduction, it is also possible to generate a spindle error signal by comparing the current rotational speed information with the predetermined CLV reference speed information.

Then, the spindle servo circuit 12 outputs a spindle drive signal generated in accordance with the spindle error signal to cause a spindle driver 17 to execute the CLV rotation of the spindle motor 2.

Moreover, the spindle servo circuit 12 generates a spindle drive signal in accordance with a spindle kick/brake control signal from the system controller 10 to execute operations such activation, stop, acceleration, and deceleration of the spindle motor 2.

The various operations of the servo system and the recording/reproducing system as described above are controlled by the system controller 10 formed of a microcomputer.

The system controller 10 executes various types of processing in accordance with commands provided from the host equipment 100 via the host interface 8.

For example, when the host equipment 100 issues a write command, the system controller 10 first moves the optical pick-up 1 to an address to which a write operation is made. Then, the system controller 10 causes the encoding/decoding section 7 to execute encoding processing as described above on data transferred from the host equipment 100 (for example, video data and audio data). The laser driver 13 is then driven to emit a laser beam in accordance with the data encoded as described above, thus executing the recording.

In addition, when the host equipment 100 issues a read command that requests transfer of certain data recorded on the optical disc 90, for example, the system controller 10 first performs control of a seek operation with a designated address being as a target. Specifically, the system controller 10 issues a command to instruct the optical block servo circuit 11 to execute an access operation of the optical pick-up 1 with the address designated by the seek command as a target.

After that, operation control necessary for transferring data within the designated data section to the host equipment 100 is performed. Specifically, the data is read out from the optical disc 90 and the reproduction processing is executed in the data detection processing section 5 and the encoding/decoding section 7, thus transferring the requested data.

The RF signal obtained in the matrix circuit 4 is also supplied to the modulation-degree measurement section 19. The modulation-degree measurement section 19 measures a modulation degree of the reproduced RF signal and supplies it to the system controller 10 when performing an OPC operation described later.

The modulation degree corresponds to an amplitude level of an RF signal waveform. For example, when a top level of an amplitude of the RF signal is denoted by LH, a bottom level thereof is denoted by LL, and a level under no-signal conditions is denoted by LZ at a time of reproducing a predetermined T mark, the modulation degree is represented by (LH−LL)/(LH−LZ).

A memory section 20 stores parameters and constants used by the system controller 10 in various types of processing. For example, the memory section 20 is constituted of a nonvolatile memory.

It should be noted that in the example of FIG. 1, the disc drive apparatus that is connected to the host equipment 100 has been described. However, the disc drive apparatus according to the embodiment may have a different structure as not being connected to another equipment. In this case, an operation section or a display section is added or a structure of a data input/output interface portion becomes different from that of FIG. 1. In other words, it is only necessary to form terminal portions for inputting and outputting various pieces of data together with performing recording and reproduction in accordance with user operations. Of course, other various structural examples of the disc drive apparatus may be conceivable.

When performing a recording operation on the optical disc 90, the disc drive apparatus performs adjustment processing to obtain an optimum recording laser power (OPC processing) before an actual recording operation.

The adjustment of a laser power is made by executing test writing on a test area provided in the optical disc 90 (OPC area).

Judgment processing of the optimum recording laser power may be executed after the optical disc 90 is mounted or immediately before the recording is actually performed, for example.

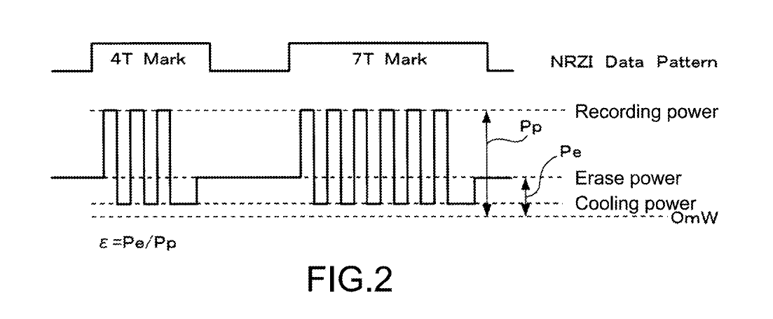

Prior to descriptions of the OPC processing, a waveform of a laser drive signal at the time of recording will be described with reference to FIG. 2.

FIG. 2 shows an example of a waveform of a laser drive signal that is formed in the write strategy section 14 and given to the laser diode of the optical pick-up 1 by the laser driver 13.

Here, an example in which waveforms of a 4T mark and a 7T mark are formed is shown. It should be noted that “T” represents a channel clock cycle.

The waveform of the laser drive signal is set to a pulse train waveform having the number of pulses corresponding to a mark length formed as shown in FIG. 2.

The pulse waveform is formed of pulse levels of a cooling power, an erase power Pe, and a recording power Pp.

In this case, (erase power Pe)/(recording power Pp) is represented as ε value that is set to be constantly fixed in this example. Specifically, a ratio of the recording power Pp to the erase power Pe is constant.

The OPC operation described below is performed assuming that the ε value is a fixed value.

### 2. OPC Operation as First Embodiment

An OPC operation as a first embodiment will be described.

The outline of the OPC operation of the first embodiment is as follows.

As a method of determining an optimum recording power with respect to the optical disc 90 as a phase-change medium, a normal write operation is first performed on a test area by using an initial power. Then, an erase operation is performed on the test area while varying an erase power in a predetermined range with the initial power being set as a maximum value. After the erase, a modulation degree of the remaining RF signal in the test area is measured, to thereby obtain an erase characteristic curve.

Next, the erase is performed on the test area by using the initial power to thus obtain a completely-erased state, and a recording power with the fixed ε value is added to the erase power in the same range as the above range so that a test recording is carried out. Then, the modulation degree of a grown RF signal in the test area is measured, thus obtaining an RF growth characteristic curve.

With an intersection obtained when the erase characteristic curve and the RF growth characteristic curve overlap each other as a reference point, an optimum recording power is obtained by operation using a laser power corresponding to the reference point.

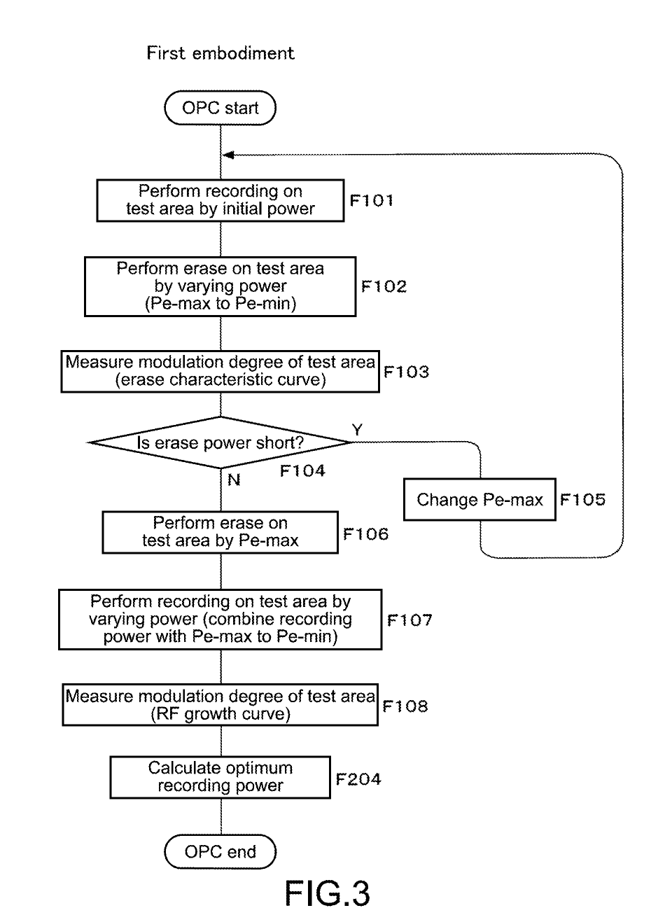

With reference to FIGS. 3 to 6, a specific example of the OPC processing will be described.

FIG. 3 shows processing of the system controller 10 when performing the OPC operation.

It should be noted that when the optical disc 90 is mounted to the disc drive apparatus, a disc type is identified and an initial power for the OPC processing is determined for each disc type by the time the OPC operation is started. The disc type used herein includes a disc manufacturer, a production year, a product model, and the like.

The initial power may be determined by a designer in advance for each disc type, or may be determined based on information recorded as management information (laser power recommended value) on the disc.

The initial power is necessary to have a power intensity capable of obtaining a sufficient modulation degree of a reproduced signal and sufficiently performing erase when the recording is carried out on the disc of corresponding type, but a recording quality is not seen as a problem.

As Step F101, the system controller 10 first carries out a normal recording using an initial power on a test area of the optical disc 90.

Specifically, the system controller 10 causes the optical pick-up 1 to access the test area of the optical disc 90 and controls the write strategy section 14 and the laser driver 13 to execute a recording operation by a recording power Pp with a fixed value based on the initial power above. It should be noted that as test recording data, recording data for forming predetermined mark/space patterns is output from the encoding/decoding section 7.

It should be noted that in this case, recording may be performed multiple times in consideration of overwrite recording characteristics. In addition, in order to reliably eliminate an influence of past recording marks, the test area may be subjected to DC erase before the processing of Step F101 is performed.

Subsequently, in Step F102, the system controller 10 performs an erase operation on the test area on which recording has been performed by the initial power in Step F101, while varying an erase power. Specifically, the system controller 10 causes the optical pick-up 1 to access the test area again and instructs the write strategy section 14 and the laser driver 13 to set a variation range of the erase power to be a range from Pe-max to Pe-min, in which a maximum value is the initial power and a minimum value is ⅓ of the initial power, for example. Then, the DC erase is carried out while the erase power is being varied.

In Step F103, the system controller 10 measures a modulation degree of the remaining RF signal in the test area and thus obtains an erase characteristic curve. Specifically, the system controller 10 causes the optical pick-up 1 to reproduce the test area, takes in the modulation degree that is acquired at that time in the modulation-degree measurement section 19, and obtains the erase characteristic curve.

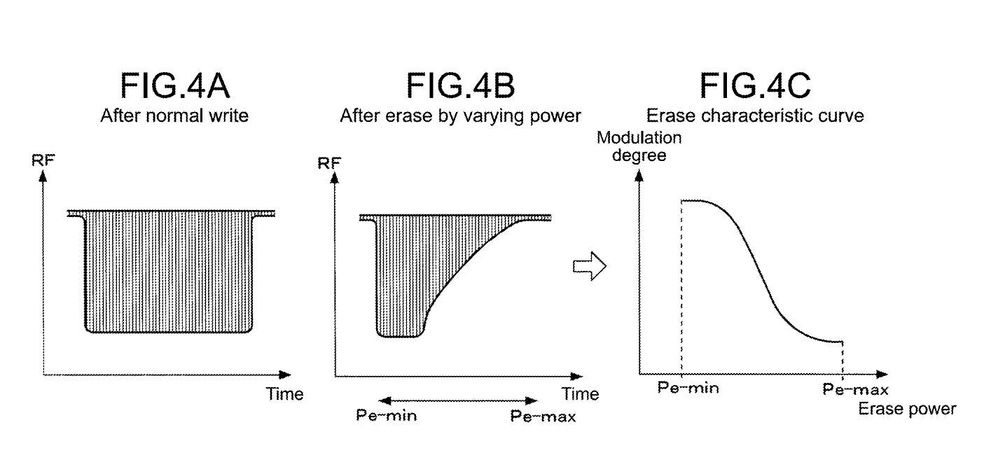

The erase characteristic curve will be described with reference to FIG. 4.

FIG. 4A shows an RF signal waveform that is obtained when the test area is reproduced in a state where recording has been performed on the test area using a fixed power in Step F101. Due to the recording using the fixed power, the RF signal waveform having a predetermined amplitude level is obtained at the time of reproduction of the test area.

Next, in Step F102, the erase is carried out while varying the power as described above. In this case, assuming that the erase is performed while the erase power is increased from Pe-min to Pe-max, an RF signal waveform as shown in FIG. 4B is obtained by reproducing the test area after the erase, that is, in Step F103.

Specifically, at a stage at which the erase power is low, the recording marks are hardly erased. However, as the erase power is being increased, the erase of the recording marks advances and the marks are almost completely erased when using the erase power Pe-max. As a result, though in the RF signal waveform, a large amplitude remains in a portion subjected to the erase using a low erase power, the amplitude level is gradually reduced.

In Step F103, the RF signal waveform of the state shown in FIG. 4B is supplied to the modulation-degree measurement section 19 and the modulation degree thereof is measured.

Accordingly, the system controller 10 obtains the erase characteristic curve as shown in FIG. 4C. Specifically, obtained is a curve showing the modulation degree of the remaining RF signal in accordance with the erase power in a case where the abscissa axis is the erase power and the ordinate axis is the modulation degree.

It should be noted that in a case where the erase power Pe-max does not have enough power to sufficiently perform the erase up to this point, the RF signal waveform as shown in FIG. 4B is not obtained. In other words, there may be a case where the erase is not sufficiently performed even in an erased portion by the erase power Pe-max, which may lead to a state where a relatively-high modulation degree remains.

Accordingly, in a case where the modulation degree of the portion erased by the erase power Pe-max is not sufficiently low, the system controller 10 judges in Step F104 that the erase power Pe-max is not appropriate (short of erase power). Then, the system controller 10 proceeds to Step F105 to change (upwardly revise) the value of the erase power Pe-max having the maximum level, and starts again from Step F101.

In a case where the erase characteristic curve as shown in FIG. 4C is appropriately obtained through Steps F101 to F103, the system controller 10 processes to Step F106. Next, the system controller 10 performs processing for obtaining an RF growth characteristic curve.

In Step F106, the system controller 10 first controls the optical pick-up 1, the write strategy section 14, and the laser driver 13 to temporarily execute the DC erase on the test area by using the erase power Pe-max.

It should be noted that though the DC erase is carried out assuming that the same test area as that used in Steps F101 to F103 is used for processing in Step F107 and subsequent steps, another test area that has been subjected the DC erase (or unused) may be used. In this case, the processing of Step F106 is unnecessary.

Subsequently, the system controller 10 controls the optical pick-up 1, the write strategy section 14, and the laser driver 13 to execute the test recording on the test area in the completely-erased state, while varying the erase power such that the erase power falls in a range from Pe-max to Pe-min. At this time, the recording power is output such that the ε value is constant.

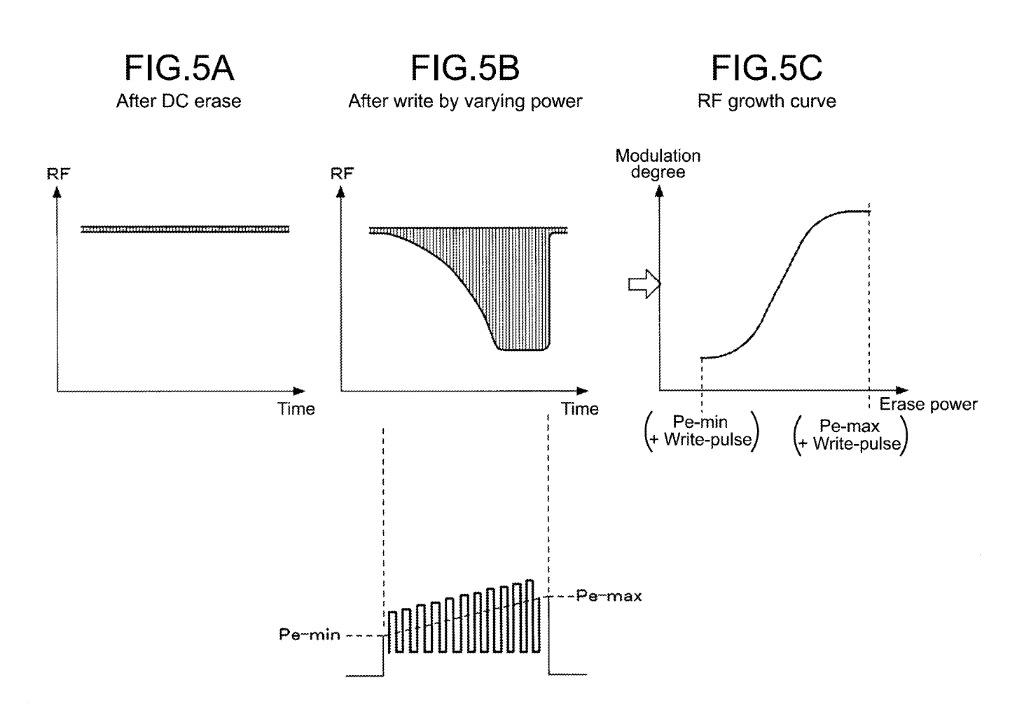

This operation will be described with reference to FIGS. 5A to 5C.

FIG. 5A shows an RF signal waveform obtained by reproducing the test area in the completely-erased state. Because of the completely-erased state, there is no RF signal waveform amplitude and only a noise level exists.

The upper portion of FIG. 5B is an RF signal waveform obtained by performing reproduction after the recording in Step F107.

The execution of the test recording while varying the erase power in the range from Pe-max to Pe-min as described above means that the recording is carried out in a waveform of the laser drive signal as shown in the lower portion of FIG. 5B.

Specifically, the recording is performed in a waveform of a laser drive signal in which the erase power is combined with recording pulses based on the recording power determined by the ε value, while the erase power is gradually varied from Pe-min to Pe-max.

By performing the recording in such a waveform of a laser drive signal, marks are not sufficiently formed in a state where the erase power is low, that is, the recording power is low. However, as the erase power becomes high, that is, the recording power becomes high, marks are formed reliably. Accordingly, when the reproduction is performed after that recording, the RF signal waveform as shown in the upper portion of FIG. 5B is obtained.

Next, the system controller 10 measures a modulation degree of the RF signal in the test area to thus obtain an RF growth characteristic curve. Specifically, the system controller 10 causes the optical pick-up 1 to reproduce the test area, takes in the modulation degree that is acquired at that time in the modulation-degree measurement section 19, and obtains the RF growth characteristic curve.

In this case, an RF signal waveform obtained by reproducing the test area is as shown in FIG. 5B as described above. In Step F108, the RF signal waveform in the state of FIG. 5B is supplied to the modulation-degree measurement section 19 and the modulation degree is measured.

Accordingly, the system controller 10 obtains the RF growth characteristic curve as shown in FIG. 5C. Specifically, the system controller 10 obtains, in a case where the abscissa axis is the erase power and the ordinate axis is the modulation degree, a curve showing the modulation degree of the RF signal in accordance with the erase power determined by the ε value while varying the erase power.

Since the erase characteristic curve and the RF growth characteristic curve are obtained by the above processing, the system controller 10 calculates an optimum recording power with the use of the erase characteristic curve and the RF growth characteristic curve in Step F109.

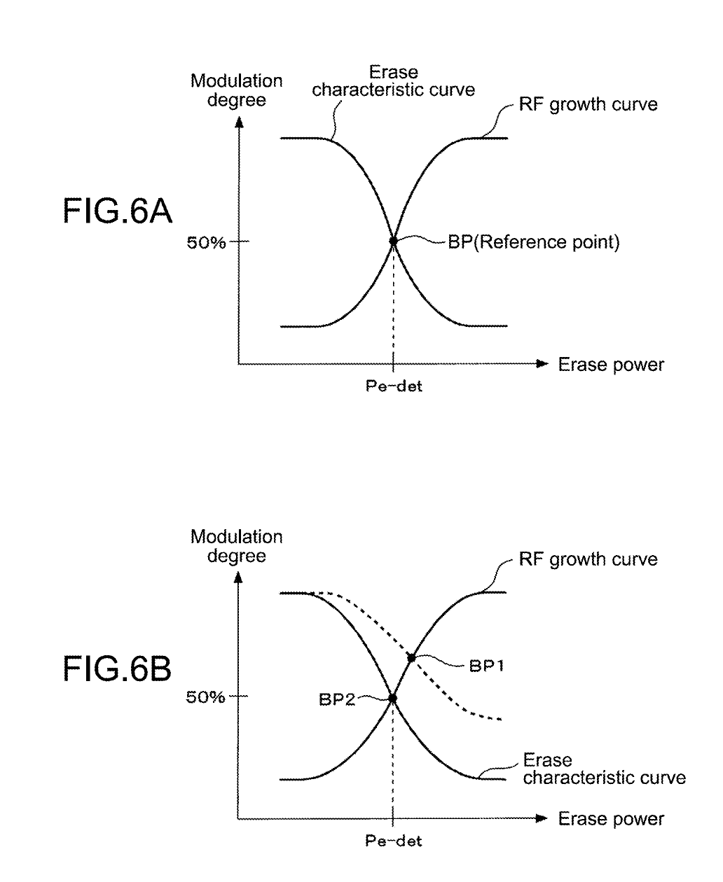

FIG. 6 show the erase characteristic curve and the RF growth characteristic curve together.

Here, an intersection of the erase characteristic curve and the RF growth characteristic curve, that is, a point at which modulation degrees thereof coincide is set as a reference point BP. The erase power corresponding to the reference point BP is represented as Pe-det.

In addition, a value obtained by multiplying the erase power Pe-det by a predetermined coefficient K is represented as an optimum erase power Pe-result.

It should be noted that the coefficient K is a value calculated by investigating various discs in a design process and the like before shipping thereof and is a coefficient value stored in the memory section 20 of the disc drive apparatus in accordance with the disc types.

As described above, a relationship between the erase power and the recording power is fixed to the ε value (=Pe/Pp).

As a result, an optimum recording power is determined using the ε value after the optimum erase power Pe-result is determined.

The system controller 10 sets the optimum recording power as described above and thereafter makes a setting so that the recording is made using the optimum recording power in the recording operation performed on the optical disc 90.

According to the OPC processing of this embodiment, it becomes possible to operate distribution of the OPC results with only a specific coefficient K instead of a plurality of parameters required in related art, with the result that the number of processes can be largely reduced when a large number of discs are investigated in actual mass production design.

In the past, for example, a plurality of parameters that influence each other, such as a target γ value and a ρ ratio, have been set in consideration of each value while corresponding to various types of discs, and therefore the parameter setting has been an extremely troublesome operation. In this embodiment, however, the coefficient K corresponding to the various types of discs only needs to be determined in advance. In other words, the recording power may be determined using one parameter obtained from the reference erase power Pe-det, with the result that the parameter setting operation is extremely simplified.

In addition, as found from FIG. 6, the reference point BP can be set to be a point whose modulation degree is not so low. For example, such a point is set to be a point whose modulation degree is about 50%.

As described above, in an area whose modulation degree is low, for example, about 30%, measurement accuracy is unstable. In this embodiment, however, the OPC results can be calculated without using results obtained from an RF signal having a low modulation degree of unstable measurement accuracy, with the result that power determination accuracy can be improved.

Moreover, a maximum value of the power with which test recording is performed corresponds to a fixed recording power based on the initial power. Since a power largely exceeding an optimum power is not used in the test, there is no fear that the test area of the disc 90 may be damaged.

### 3. OPC Operation as Second Embodiment

An OPC operation of a second embodiment will be described.

In the OPC operation of the first embodiment, the reference point BP shown in FIG. 6A, i.e., the intersection of the erase characteristic curve and the RF growth characteristic curve may be at a position whose modulation degree is too high in some cases. For example, it is a case where the erase characteristic curve is as indicated by a broken line shown in FIG. 6B. A reference point BP1 of this case is a point having a high modulation degree.

In such a case, the erase characteristic curve and the RF growth characteristic curve intersect at an obtuse angle as compared to the case of FIG. 6A. Though the erase power Pe-det at the reference point is necessary to be obtained as the intersection of the erase characteristic curve and the RF growth characteristic curve, when both the curves intersect at an obtuse angle, an error of a point on the abscissa axis (that is, erase power) of FIG. 6B becomes large. Specifically, variation of the modulation degree that is caused by sensitivity variation of the disc 90 tends to influence a power value indicated by the intersection. This leads to lowering of the determination accuracy of the reference erase power Pe-det and causing a fear that sufficient power determination accuracy may not be obtained.

Accordingly, it is desirable to obtain the erase characteristic curve as indicated by a solid line of FIG. 6B and use a reference point BP2 at which both the curves intersect at a relatively-acute angle.

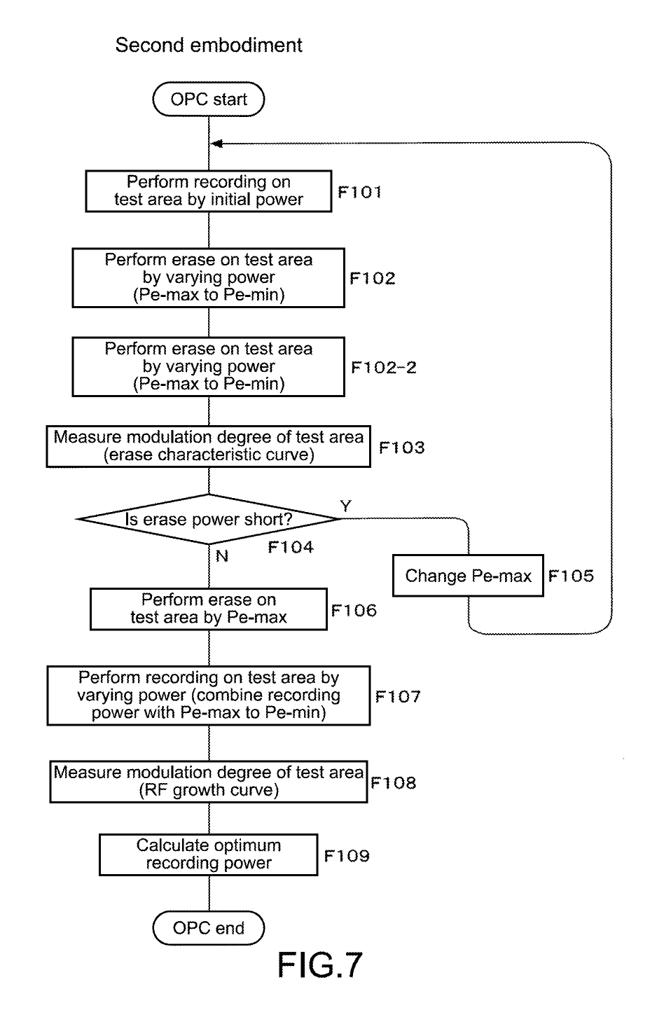

In this regard, the system controller 10 performs processing of FIG. 7 in the second embodiment.

It should be noted that processing of Steps F101 to F109 of FIG. 7 are the same as those of FIG. 3, and therefore descriptions thereof are omitted. In FIG. 7, processing of Step F102-2 is added next to Step F102.

In Step F102-2, the same processing as in Step F102 is performed. That is, the test area on which recording has been performed by the initial power in Step F101 is erased while varying the erase power in the range from Pe-max to Pe-min. In other words, the erase operation executed while varying the erase power is repeated twice.

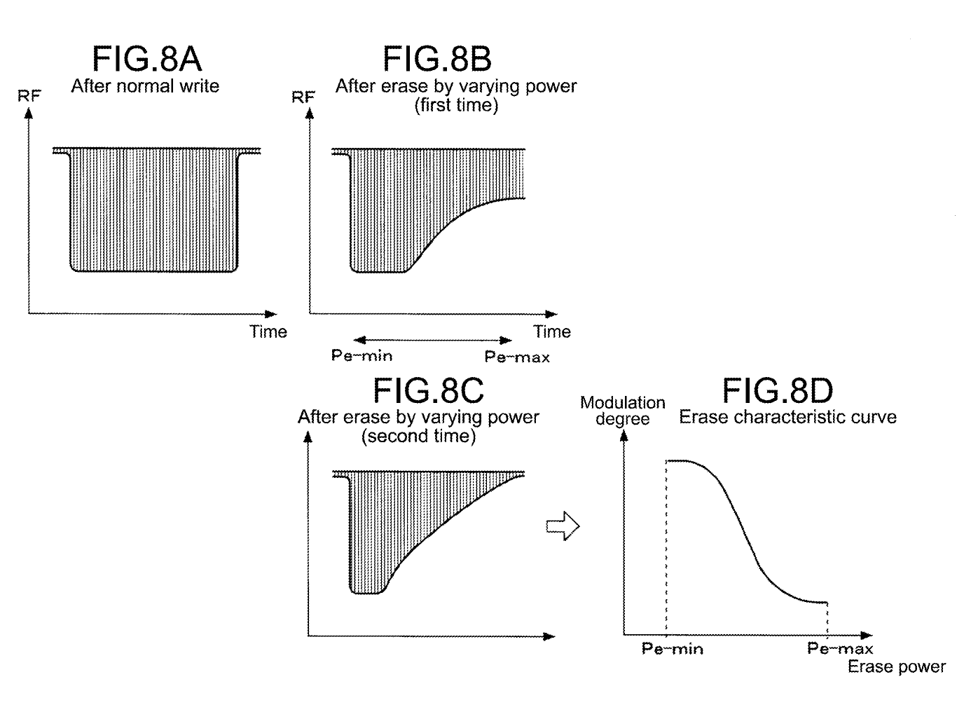

The meaning of this processing is described with reference to FIG. 8.

FIG. 8A shows an RF signal waveform obtained when reproduction of a test area is performed in a state where recording has been made on the test area by a fixed power in Step F101. Similar to the case of FIG. 4A, due to the recording by the fixed power, the RF signal waveform having a predetermined amplitude level is obtained at the time of reproduction of the test area as shown in FIG. 8A.

Next, in Step F102, the erase is carried out while varying the power as described above. In this case, it is assumed that the erase is performed while the ease power is increased from Pe-min to Pe-max. However, when the erase is not performed sufficiently due to characteristics and the like of the medium, the RF signal waveform obtained by reproducing the test area is as shown in FIG. 8B.

When an erase characteristic curve is tried to be obtained in this state, a curve as indicated by the broken line of FIG. 6B is obtained.

Accordingly, the erase is performed again while varying the power in Step F102-2. As a result, in Step F103 after the second erase, the RF signal waveform obtained by reproducing the test area is as shown in FIG. 8C. From this RF signal waveform, the erase characteristic curve as shown in FIG. 8D, that is, the erase characteristic curve of the solid line of FIG. 6B is obtained.

The processing performed after the erase characteristic curve is obtained in such a manner (F104 to F109) are the same as in the first embodiment. Specifically, the RF growth characteristic curve is obtained and then the reference erase power Pe-det is obtained from the reference point BP2 as the intersection of the erase characteristic curve and the RF growth characteristic curve. The optimum erase power Pe-result is calculated by multiplying the erase power Pe-det by the coefficient K. The optimum recording power is determined using the ε value after the optimum erase power Pe-result is determined.

The system controller 10 sets the optimum recording power as described above and thereafter makes a setting so that the recording is made using the optimum recording power in the recording operation performed on the optical disc 90.

According to the second embodiment described above, the same effect as that in the first embodiment can be achieved. In addition, the recording power setting with high accuracy can be carried out while supporting a case where the erase characteristic curve is not obtained satisfactorily due to the characteristics and the like of the medium.

### 4. OPC Operation as Third Embodiment

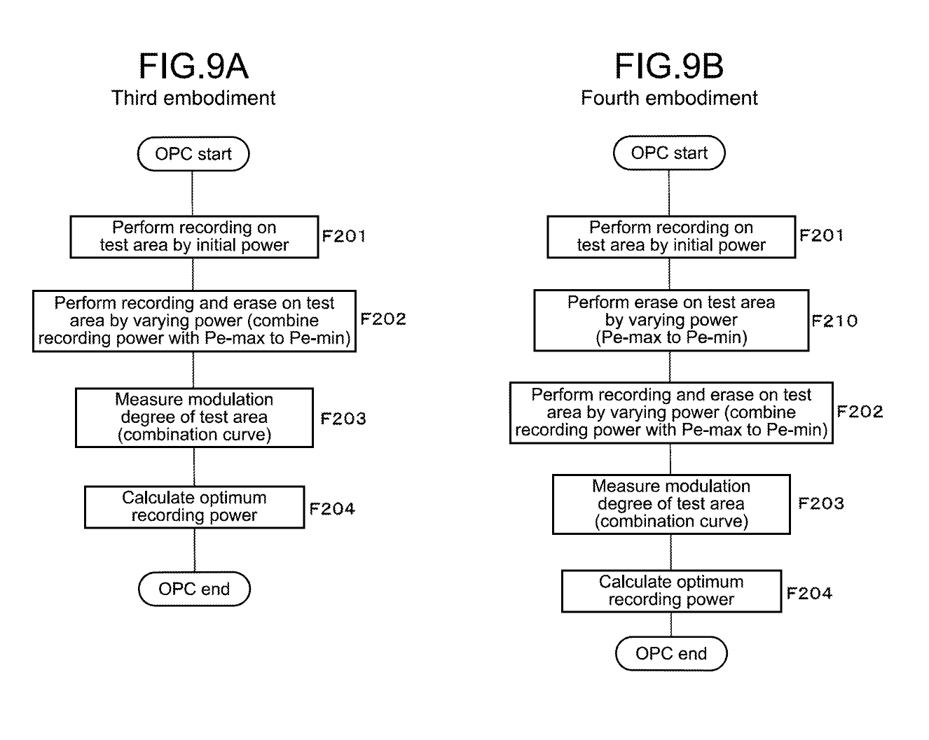

A third embodiment will be described with reference to FIGS. 9A, 10, and 11.

The basic idea of the OPC operation in this embodiment is the same as that in the first embodiment, but the third embodiment is an example in which the OPC operation is executed more efficiently.

Specifically, the initial recording is first performed using the initial power, and recording and erase are subsequently performed on the same area while varying the power in a predetermined range with the initial power being set as a maximum value. In this case, a position at which a mark is formed in recording by the initial power is made different from a position at which a mark is formed in a case where the recording and erase are performed with the power being varied. In addition, an NRZI data pattern in which an area subjected to the recording by the initial power is erased is used.

FIG. 9A shows processing of the system controller 10 when the OPC operation is executed.

Also in this case, it is assumed that when the optical disc 90 is mounted to the disc drive apparatus, a disc type thereof is identified and an initial power for the OPC processing is determined for each disc type by the time the OPC operation is started. The initial power may be determined by a designer in advance for each disc type, or may be determined based on information recorded as management information (laser power recommended value) on the disc. The initial power is necessary to have a power intensity capable of obtaining a sufficient modulation degree of a reproduced signal and sufficiently performing erase when the recording is carried out on the disc of corresponding type, but a recording quality is not seen as a problem.

In Step F201, the system controller 10 controls the optical pick-up 1, the laser driver 13, and the write strategy section 14 to execute a normal recording operation on the test area using the initial power. In this case, the recording may be performed multiple times in consideration of overwrite recording characteristics. In addition, the test area may be subjected to the DC erase before the processing of Step F201.

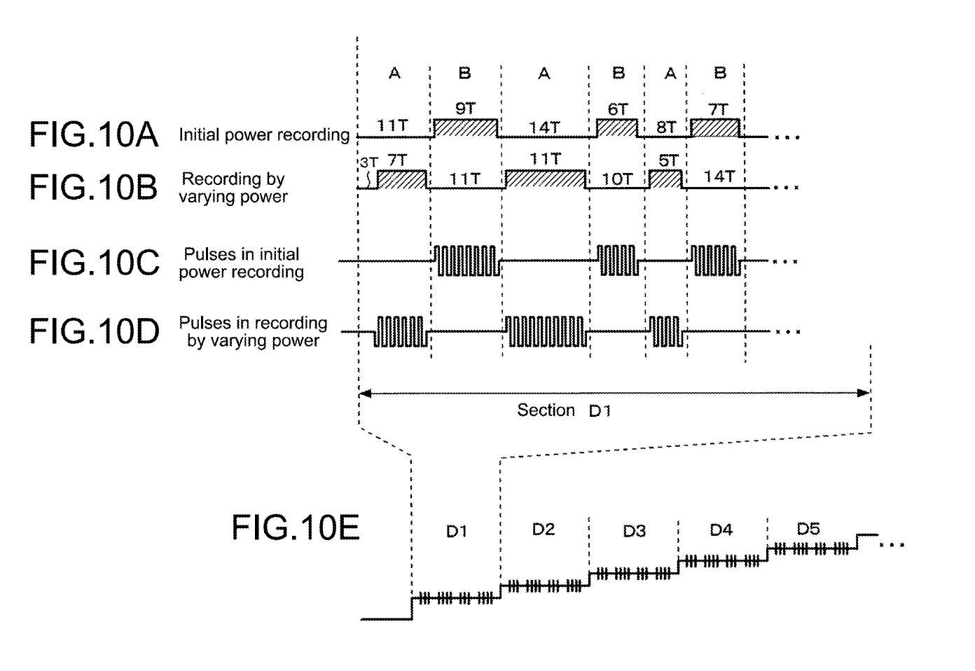

Here, the NRZI data pattern used for recording is, for example, a pattern as shown in FIG. 10A. The system controller 10 causes the encoding/decoding section 7 to generate such a test-recording pattern and the write strategy section 14 to supply the pattern. The write strategy section 14 generates a waveform of a laser drive signal as shown in FIG. 10C and supplies it to the laser driver 13.

Accordingly, in the test area of the optical disc 90, an area A is set as a space and an area B is set as a mark.

For example, a 9T mark, a 6T mark, a 7T mark, and the like are formed.

It should be noted that the NRZI data pattern shown in FIG. 10A is merely an example. Further, patterns having various T marks/spaces are not necessarily used. Alternatively, patterns having marks/spaces of a constant T length may be used. It should be noted that marks/spaces that are varied in length are suitable in terms of servo stability.

Next, the system controller 10 executes the recording and erase on the test area while varying the erase power to be in the range from Pe-max to Pe-min in Step F202. In this case, the recording power is output such that the ε value becomes constant.

The NRZI data pattern used for recording is assumed to be a pattern as shown in FIG. 10B. For example, the system controller 10 causes the encoding/decoding section 7 to generate such a test recording/erase pattern and the write strategy section 14 to supply the pattern. The write strategy section 14 generates a waveform of a laser drive signal as shown in FIG. 10D and supplies it to the laser driver 13.

Further, the system controller 10 changes the erase power Pe in a stepwise manner as shown in FIG. 10E.

Assuming that a predetermined section including the data patterns of FIGS. 10A and 10B is set as a section D1 in the test area, the operations of Steps F201 and F202 are performed over n sections when the sections are set as sections D1, D2, . . . , Dn. In this case, in Step F202, the erase power (and recording power determined by ε value from erased power) is changed in each section as shown in FIG. 10E.

In Step F202, the laser diode of the optical pick-up 1 outputs a laser beam in accordance with the waveform of the laser drive signal shown in FIG. 10D. Accordingly, marks are formed in the areas A and erase is performed in the areas B. In other words, the marks recorded in the areas B by the initial power in Step F201 are erased.

Further, the recording power for forming the marks in Step F202 is gradually increased in the sections D1, D2, . . . , and the erase power is also increased gradually.

Next, the system controller 10 measures a modulation degree of the test area in Step F203 and obtains a combination characteristic curve that is obtained by combining an erase characteristic curve and an RF growth characteristic curve. Specifically, the system controller 10 causes the optical pick-up 1 to reproduce the test area and takes in the modulation degree obtained by the modulation-degree measurement section 19, thus obtaining the combination characteristic curve.

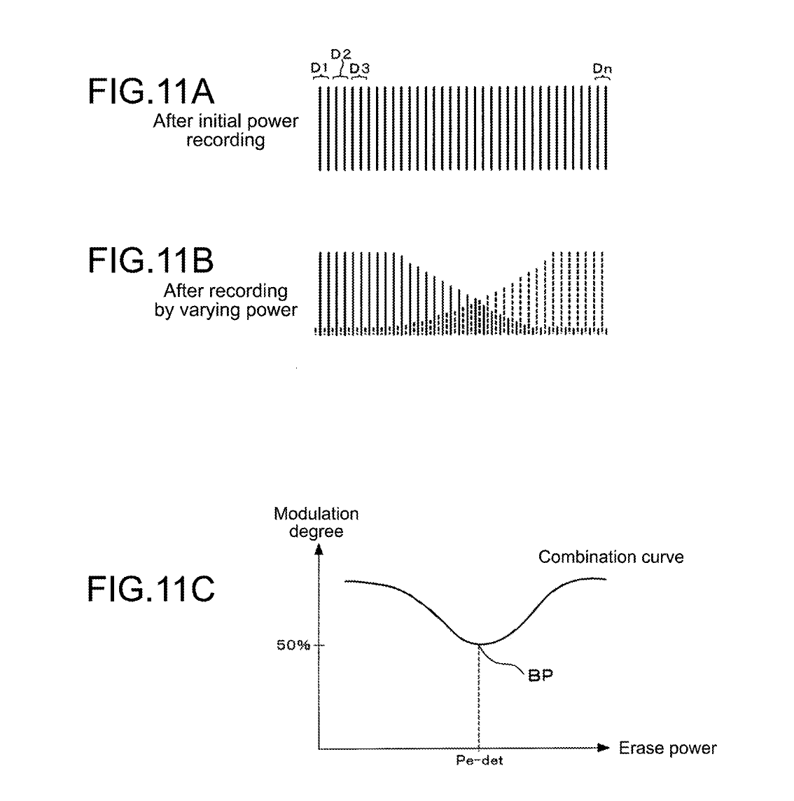

The combination characteristic curve will be described with reference to FIG. 11.

FIG. 11A schematically shows an RF signal waveform obtained by reproducing a test area in a state where recording has been performed on the test area by a fixed power in Step F201.

It should be noted that in FIG. 11A, one solid line represents an amplitude of the RF signal in the area B shown in FIG. 10. As seen in FIG. 10, for example, many areas B are present in each of the sections D1, D2, . . . , Dn, whereas in FIG. 11A, the amplitude of the RF signal is represented by only two solid lines (two areas B) in each of the sections D1, D2, . . . , Dn for convenience of illustration.

Since the recording is performed by the fixed power in Step F201, the RF signal waveform of a predetermined amplitude level on the area B is obtained when the test area is reproduced, as shown in FIG. 11A.

Next, the power is varied in Step F202 as described above, and recording on the areas A and erase of the areas B are performed. In this case, the erase is performed while increasing the erase power from Pe-min to Pe-max. After the erase operation, that is, in Step F203, the RF signal amplitude obtained by reproducing the test area is as shown in FIG. 11B.

In FIG. 11B, broken lines represent the RF signal amplitude on the areas A.

Specifically, at a stage at which the erase power is low, marks are not sufficiently formed in the areas A and erase of the areas B is not sufficiently performed. The erase of the recording marks in the areas B advances and sufficient marks are gradually formed in the areas A as the erase power becomes high.

As a result, by reproducing the sections D1 to Dn, the RF signal amplitude as shown in the figure is obtained.

In Step F203, the RF signal waveform in the state of FIG. 11B is supplied to the modulation-degree measurement section 19 and thus the modulation degree is measured.

Accordingly, the system controller 10 can obtain the combination characteristic curve as shown in FIG. 11C. Specifically, obtained is a curve showing a modulation degree of an RF signal in accordance with the erase power in a case where the abscissa axis is an erase power and the ordinate axis is the modulation degree.

Here, the solid lines of FIG. 11B correspond to an RF signal waveform that is used for obtaining an erase characteristic curve in the first embodiment described above and the broken lines correspond to an RF signal waveform used for obtaining an RF growth characteristic curve.

Specifically, the combination characteristic curve shown in FIG. 11C is obtained as a curve combining an erase characteristic curve and an RF growth characteristic curve.

In the combination characteristic curve, a point at which the modulation degree becomes minimum is represented as reference point BP.

As described above, the areas A capable of obtaining the RF growth characteristic curve and the areas B capable of obtaining the erase characteristic curve are alternately repeated in the test area. Since a growth level of the RF in the areas A is lower than that of the remaining RF in the areas B on the lower erase power side of the reference point BP at which the modulation degree is minimum, the erase characteristic curve is seen. On the other hand, since the growth level of the remaining RF in the areas B is lower than that of the RF in the areas A on the higher erase power side of the reference point BP, the RF growth characteristic curve is seen. Specifically, a search for a minimum value of the combination characteristic curve shown in FIG. 11C corresponds to a search for the intersection of FIG. 6A in the first embodiment.

In other words, the same effect as that obtained in Steps F101 to F108 of FIG. 3 can be obtained in Steps F201 to F203 of FIG. 9A.

Since the combination characteristic curve is obtained, the system controller 10 calculates an optimum recording power in Step F204.

Specifically, an erase power corresponding to the reference point BP of FIG. 11C is denoted by Pe-det.

Then, a value obtained by multiplying the erase power Pe-det by a predetermined coefficient K is represented as an optimum erase power Pe-result. The optimum recording power is determined using the ε value after the optimum erase power Pe-result is determined.

The system controller 10 sets the optimum recording power as described above and thereafter makes a setting so that the recording is made using the optimum recording power in the recording operation performed on the optical disc 90.

According to the third embodiment as described above, the same effect as that of the first embodiment can be obtained. In addition, by simultaneously performing the erase and recording while varying the power in Step F202, it is possible to make the whole OPC operation more efficient and reduce a time for the OPC processing.

### 5. OPC Operation as Fourth Embodiment

An OPC operation of a fourth embodiment will be described.

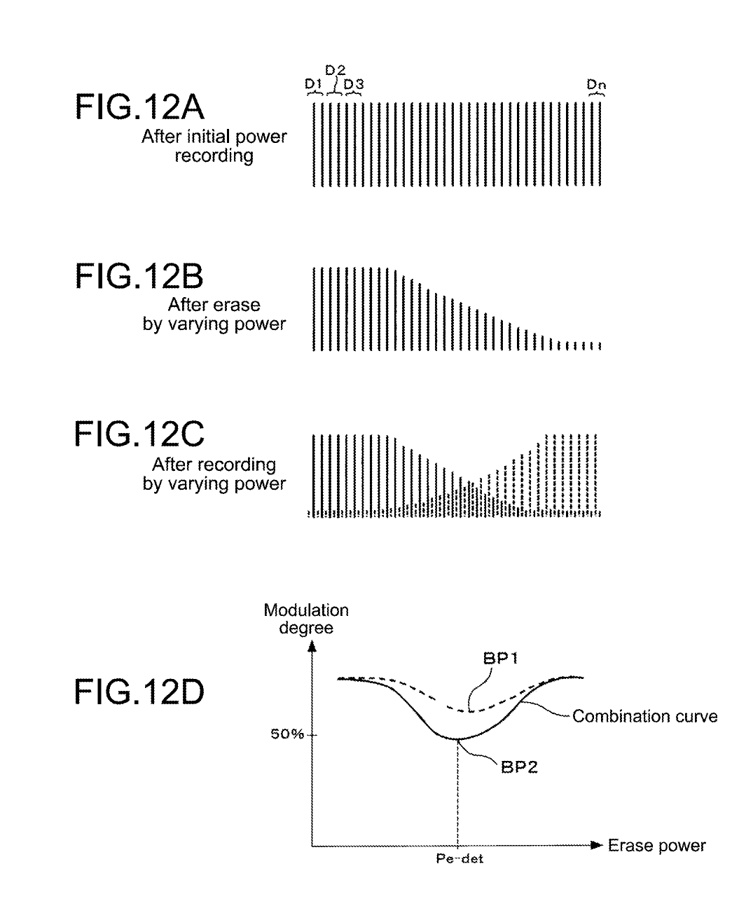

In the OPC operation of the third embodiment, the reference point BP shown in FIG. 11C, that is, the minimum value of the combination characteristic curve may be at a position whose modulation degree is too high in some cases. For example, it is a case where the combination characteristic curve becomes a curve as indicated by a broken line of FIG. 12D. A reference point BP1 of this case is a point having a high modulation degree.

In such a case, an angle showing a bottom of the combination characteristic curve is obtuse and thus variation of the modulation degree that is caused by sensitivity variation of the optical disc 90 tends to influence a power value indicated by the minimum vale. This leads to a fear that sufficient power determination accuracy may not be obtained. The fourth embodiment is applied in such a case.

In the fourth embodiment, the system controller 10 performs processing of FIG. 9B. It should be noted that processing of Steps F201 to F204 of FIG. 9B are the same as those of FIG. 9A, and therefore descriptions thereof are omitted. In FIG. 9B, processing of Step F210 is added next to Step F201.

In Step F201, the system controller 10 first executes recording on the test area by the initial power (see FIGS. 10A and 10C). If reproduction is performed while keeping this state, an amplitude of a reproduced signal is obtained as shown in FIG. 12A (similar to FIG. 11A).

Next, in Step F210, the system controller 10 performs erase on the test area while varying the erase power in the range from Pe-max to Pe-min. Here, only the erase is performed, in which the erase power is varied for each section as shown in FIG. 10E whereas recording pulses do not overlap. Accordingly, the erase of the marks in the areas B on which recording has been made using the initial power is merely carried out.

If the reproduction is performed while keeping this state, the amplitude of the reproduced signal is obtained as shown in FIG. 12B.

Next, in Step F202, the system controller 10 performs the recording and erase on the test area while varying the power (see FIGS. 10B, 10D, and 10E).

Specifically, as well as performing the second erase on the areas B, the recording is performed on the areas A by varying the power.

Accordingly, at a stage of Step F203, an RF signal waveform obtained by reproducing the test area is as shown in FIG. 12C. From this RF signal waveform, the combination characteristic curve indicated by the solid line of FIG. 12D can be obtained and then a reference point BP2 can be obtained.

After the combination characteristic curve is obtained as described above, the optimum recording power is calculated in Step F204 as in the third embodiment. Specifically, the reference erase power Pe-det is obtained from the reference point BP2 having the lowest modulation degree on the combination characteristic curve. Then, the optimum erase power Pe-result is obtained by multiplying the erase power Pe-det by a predetermined coefficient K. The optimum recording power is determined using the ε value after the optimum erase power Pe-result is determined.

The system controller 10 sets the optimum recording power as described above and thereafter makes a setting so that the recording is made using the optimum recording power in the recording operation performed on the optical disc 90.

According to the fourth embodiment as described above, the same effect as that in the third embodiment can be attained. In addition, the recording power setting with high accuracy can be carried out while supporting a case where combination characteristics in which erase characteristics are not obtained satisfactorily due to the characteristics and the like of the medium are obtained.

### 6. Test Results of OPC Operations According to Embodiments

Hereinabove, the OPC operations of the first to fourth embodiments has been described. Here, test results with which those OPC operations are considered to be practically suitable are shown.

In the experiments, three types of optical discs made in 2005, 2006, and 2007 were used as DVD+RW media, and two disc drive apparatuses were used as apparatuses #1 and #2. Then, tests (1) to (4) below were carried out.

(1) To check whether differences among the media can be absorbed by the OPC, a power margin test is performed on the three types of optical discs by using the apparatus #1.

(2) Next, using the apparatus #1, OPC results on the three types of optical discs are plotted.

By checking the results of (1) and (2) above, it is confirmed that the differences among the media are absorbed by the OPC.

(3) To additionally check whether a difference between the apparatuses can be absorbed by the OPC, a power margin test is performed on the optical disc made in 2007 by using the apparatus #2.

(4) Next, using the apparatus #2, OPC results on the optical disc made in 2007 are plotted.

By checking the results of the power margin test and OPC on the optical disc made in 2007 by using the apparatus #1 and those obtained by using the apparatus #2, it is confirmed that the difference between the apparatuses is absorbed by the OPC.

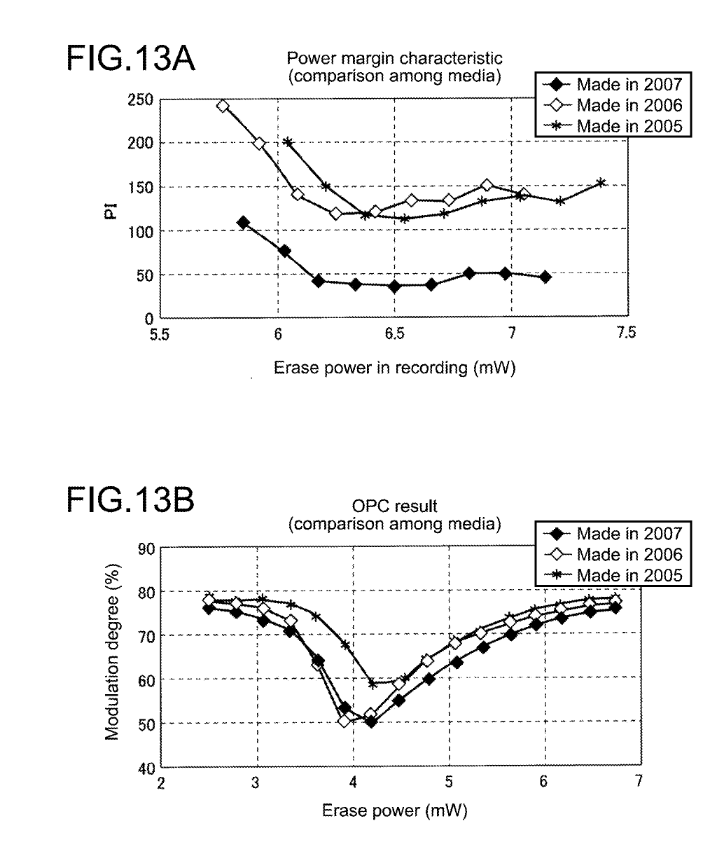

FIG. 13A shows the results of (1) above. Specifically, in order to confirm that variations among media commercially available can be absorbed by the OPC operation of this embodiment, the results were obtained by preparing the three types of optical discs whose identifications ID are the same but production years are different from each other, and performing the power margin test on the optical discs using the apparatus #1. In FIG. 13A, the ordinate axis is a PI error and the abscissa axis is the erase power in the recording.

As seen from the results, the optimum powers for the optical discs made in 2006 and 2007 are substantially the same but the optical disc made in 2005 needs a relatively-high power.

Then, as (2) above, FIG. 13B shows the results obtained by investigating the OPC results of the three types of optical discs by using the apparatus #1 used in (1) above. FIG. 13B is obtained by plotting the OPC results of a case where the technique of the fourth embodiment is used. In FIG. 13B, the ordinate axis is the modulation degree and the abscissa axis is the erase power.

As seen from the results, only the optical disc made in 2005 has the OPC results that are relatively high, similar to the results of (1) above.

This means that this OPC operation absorbs the variations of the media.

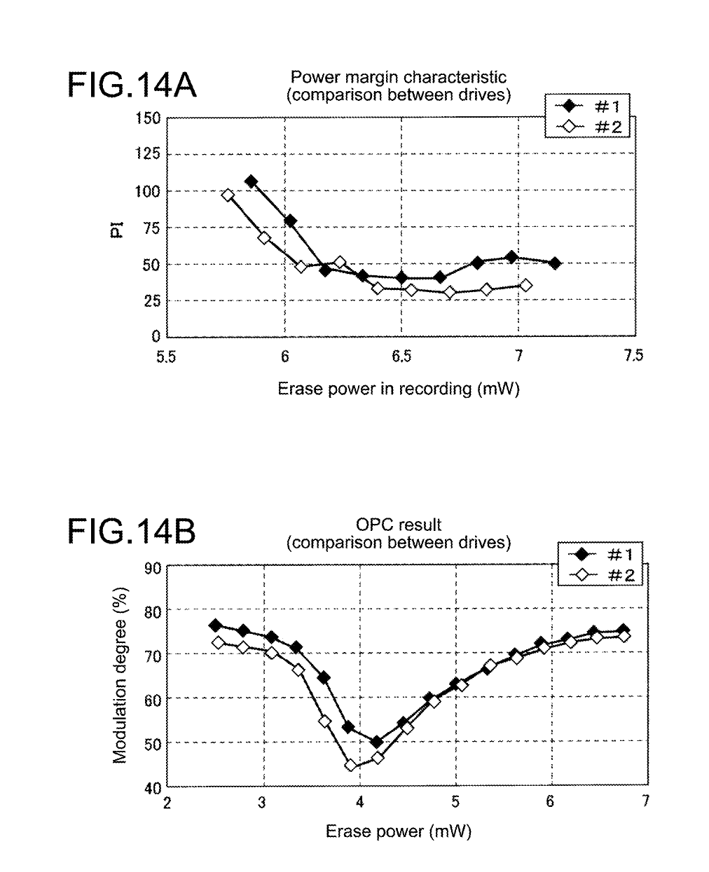

Then, as (3) described above, in order to confirm that variation between the apparatuses can be absorbed by the OPC operation of this example, the power margin test was performed on the optical disc made in 2007 by using the other apparatus #2. The results thereof are superposed on the results of the optical disc made in 2007 obtained in (1) above, to thus obtain FIG. 14A.

As seen from the results, the results of the apparatus #2 slightly shift to a low power direction as compared to those of the apparatus #1, that is, the apparatus #1 needs a higher power.

It is conceived that this is because a slight difference in power efficiency exists due to variations of optical systems, laser components, and the like.

Subsequently, as (4) above, the OPC results of the optical disc made in 2007 are investigated using the apparatus #2 used in (3) above. FIG. 14B is obtained by plotting the OPC results of the apparatuses #1 and #2 in the case where the technique of the fourth embodiment is used, as in the case of FIG. 13B.

As seen from the results, the apparatus #1 has the OPC results that are relatively high, similar to the results of (3) above.

This means that this OPC operation absorbs the variation between the apparatuses.

From the above experiments, it has been confirmed that the OPC techniques of the embodiments are appropriate.

Hereinabove, although the OPC processing of the embodiments have been described, a variety of modified examples of the present invention are conceived without being limited to the first to fourth embodiments described above.

Moreover, recording apparatuses for various optical discs such as a DVD and a Blu-ray Disc are conceivable as the recording apparatus. In addition, the present invention may also be applied to recording apparatuses for optical media other than discs.

The present application contains subject matter related to that disclosed in Japanese Priority Patent Application JP 2009-011859 filed in the Japan Patent Office on Jan. 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording apparatus, comprising:
an optical head section to irradiate a laser beam onto a recording medium and perform one of recording, reproduction, and erase of information;
a laser drive section to drive the optical head section so that the optical head section outputs the leaser beam;
a modulation-degree measurement section to measure a modulation degree of a signal read out by the optical head section; and
a control section to execute, as recording laser power setting processing by which a recording laser power output from the optical head section is set, controlling the laser drive section and the optical head section to execute the recording and the erase on a test area of the recording medium while varying a laser power, calculating a power reference value based on an erase characteristic and a reproduced signal growth characteristic in accordance with the variation of the laser power, each of the erase characteristic and the reproduced signal growth characteristic being obtained by controlling the optical head section to reproduce the test area and acquiring a modulation-degree measurement value of a reproduced signal from the modulation-degree measurement section, and setting the recording laser power by an operation using the power reference value.

2. The recording apparatus according to claim 1,
wherein the recording laser power setting processing is performed with a ratio of the recording laser power to an erase laser power being kept constant.

3. The recording apparatus according to claim 2,
wherein the control section controls the laser drive section and the optical head section to execute the recording laser power setting processing including
as first processing, performing recording on the test area by the laser power set to be a predetermined fixed value,
as second processing, performing erase on the test area subjected to the recording in the first processing while varying the laser power in a range of the fixed value or less,
as third processing, performing reproduction on the test area subjected to the erase in the second processing and calculating the erase characteristic from the modulation-degree measurement value obtained by the modulation-degree measurement section,
as fourth processing, performing the recording on the test area in a completely-erased state while varying the laser power in the range of the fixed value or less,
as fifth processing, performing the reproduction on the test area subjected to the recording in the fourth processing and calculating the reproduced signal growth characteristic from the modulation-degree measurement value obtained by the modulation-degree measurement section, and
as sixth processing, setting a power of a matching point of the erase characteristic and the reproduced signal growth characteristic as the power reference value and setting the recording laser power by the operation using the power reference value.

4. The recording apparatus according to claim 3,
wherein the control section executes the second processing multiple times.

5. The recording apparatus according to claim 2,
wherein the control section controls the laser drive section and the optical head section to execute the recording laser power setting processing including
as first processing, performing recording on the test area by the laser power set to be a predetermined fixed value and forming a mark and a space on the test area,
as second processing, performing the recording on the space and erase on the mark in the test area subjected to the recording in the first processing while varying the laser power in a range of the fixed value or less,
as third processing, performing reproduction on the test area subjected to the second processing and calculating a combination characteristic of the erase characteristic and the reproduced signal growth characteristic from the modulation-degree measurement value obtained by the modulation-degree measurement section, and
as fourth processing, setting the recording laser power by the operation using the power reference value determined from the combination characteristic.

6. The recording apparatus according to claim 2,
wherein the control section controls the laser drive section and the optical head section to execute the recording laser power setting processing including
as first processing, performing recording on the test area by the laser power set to be a predetermined fixed value and forming a mark and a space on the test area,
as second processing, performing erase on the test area subjected to the recording in the first processing while varying the laser power in a range of the fixed value or less,
as third processing, performing the recording on the space and erase on the mark in the test area subjected to the recording in the first processing while varying the laser power in the range of the fixed value or less,
as fourth processing, performing reproduction on the test area subjected to the third processing and calculating a combination characteristic of the erase characteristic and the reproduced signal growth characteristic from the modulation-degree measurement value obtained by the modulation-degree measurement section, and
as fifth processing, setting the recording laser power by the operation using the power reference value determined from the combination characteristic.

7. A recording laser power setting method, comprising:
performing recording and erase on a test area of a recording medium while varying a laser power output from an optical head section;
reproducing the test area by the optical head section and acquiring a modulation-degree measurement value of a reproduced signal;
calculating a power reference value based on an erase characteristic and a reproduced signal growth characteristic in accordance with the variation of the laser power, each of the erase characteristic and the reproduced signal growth characteristic being obtained from the modulation-degree measurement value; and
setting a recording laser power by an operation using the power reference value.
